(19) United States
(12) Patent Application Publication
(10) Pub. No.: US 2015/0346590 A1
(43) Pub. Date: Dec. 3, 2015

(54) BRANDED MONOPOD APPARATUS

(71) Applicant: Buztronics Inc., Brownsburg, IN (US)

(72) Inventor: Edward David LEWIS, Brownsburg, IN (US)

(21) Appl. No.: 14/827,528

(22) Filed: Aug. 17, 2015

Related U.S. Application Data
(60) Provisional application No. 62/187,474, filed on Jul. 1, 2015.

(51) Int. Cl. G03B 17/56; F21V 5/04; G09F 23/00; F16M 13/04; F16M 13/06

(52) U.S. Cl. CPC G03B 17/561; F16M 13/04; F16M 13/06; G09F 23/00; G03B 17/563; F21V 5/04

(57) ABSTRACT

A monopod apparatus includes a telescoping pole with a first end and a second end. A handle is coupled to the first end of the telescoping pole and an adjustable clamp including a clamp frame is coupled at the second end. The clamp frame includes at least two opposing sides defining an insert area. An advertising panel is secured within the insert area. The advertising panel being visible to others when using a recording device to record audio, video, still images or some combination thereof.

### CROSS-REFERENCE TO RELATED APPLICATIONS

This application claims the benefit of U.S. Provisional Patent Application No. 62/187,474, filed Jul. 1, 2015, titled BRANDED MONOPOD APPARATUS, which is herein entirely incorporated by reference.

### TECHNICAL FIELD

The present disclosure relates generally to a monopod apparatus and, more particularly, to a monopod apparatus configured for promotion of a product or service.

### BACKGROUND

A selfie stick is a type of monopod apparatus used to extend and secure a recording device away from a person's body so that an image or video of oneself, or a “selfie,” may be taken with the recording device. In particular, the selfie stick may be configured to support a recording device to record audio, video, still images or some combination thereof, such as a smartphone, with a portion of the selfie stick being extendible to position the recording device beyond the arm's normal reach. Selfie sticks have recently grown in popularity and, like other articles of merchandise, may be used in marketing and communication programs. For example, stickers displaying brands, logos, decals, or other advertising information may be positioned at various locations on the selfie stick. However, the placement of the stickers has typically been on the handle, providing limited visibility of the advertising information, especially for those standing behind the selfie stick. FIG. 7 illustrates a prior art selfie stick 100 including a smartphone 102 secured between a clamp top 110 and clamp bottom 108. Between opposing sides 104 and 106 is an open area exposing the rear-side of the secured smartphone 102.

### SUMMARY

The present invention may comprise one or more of the features recited in the attached claims, and/or one or more of the following features and combinations thereof.

According to one aspect of the present disclosure, a monopod apparatus includes a telescoping pole with a first end and a second end. A handle is coupled to the first end of the telescoping pole and an adjustable clamp including a clamp frame is coupled at the second end. The clamp frame includes at least two opposing sides defining an insert area. Apanel is secured within the insert area.

According to another aspect of the present disclosure, a monopod apparatus includes a telescoping pole with a first end and a second end. An adjustable clamp including a clamp frame is coupled at the second end of the telescoping pole. The clamp frame includes at least two opposing sides, with a panel coupled between the at least two opposing sides. Portions of the adjustable clamp are movable to clamp a recording device therebetween.

An illustrative embodiment of a monopod apparatus according to the present disclosure includes a selfie stick for securing a recording device away from one's person to record, for example, an image or video. The adjustable clamp of the selfie stick is used to support the recording device and also includes a clamp frame defining an insert area supporting a panel. For example, the panel may include a plastic card displaying a brand, logo, or other advertising information.

Additional features of the disclosure will become apparent to those skilled in the art upon consideration of the following detailed description of the illustrative embodiment.

### BRIEF DESCRIPTION OF THE DRAWINGS

The detailed description particularly refers to the accompanying figures in which:

FIG. 1 illustrates a front perspective view of a branded monopod apparatus according to the present disclosure;

FIG. 2 illustrates a rear perspective view of the branded monopod apparatus, and a surface having an image projected thereon from the branded monopod apparatus;

FIG. 3 illustrates a front view of an insert area and panel of the branded monopod apparatus;

FIG. 4 illustrates a rear view of the insert area and panel;

FIG. 5 illustrates a side view of the adjustable clamp, which includes the insert area, of the branded monopod apparatus;

FIG. 6 illustrates a top view of the adjustable clamp of the branded monopod apparatus; and

FIG. 7 illustrates a rear perspective view of a prior art selfie stick holding a smartphone.

### DESCRIPTION OF THE ILLUSTRATIVE EMBODIMENTS

For the purposes of promoting and understanding the principles of the invention, reference will now be made to one or more illustrative embodiments illustrated in the drawings and specific language will be used to describe the same.

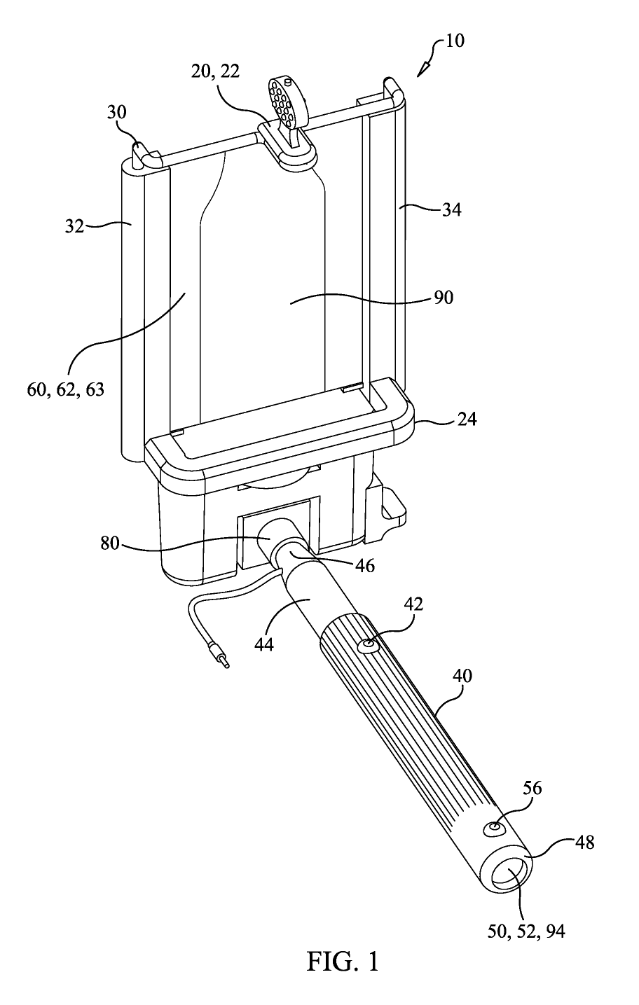

An illustrative embodiment of a branded monopod apparatus 10 according to the present disclosure is shown generally in FIGS. 1-6. The exemplary monopod apparatus 10 may be used to support a recording device, such as, for example, a smartphone, for taking pictures of oneself, or “selfies.” As such, the branded monopod apparatus 10 may also be reference throughout as a “selfie stick.” However, the branded monopod apparatus 10 may be used to support various electronic devices. Although a specific structure and purpose of the branded monopod apparatus 10 is taught herein, it should be appreciated that the teachings of the present disclosure have broader applicability.

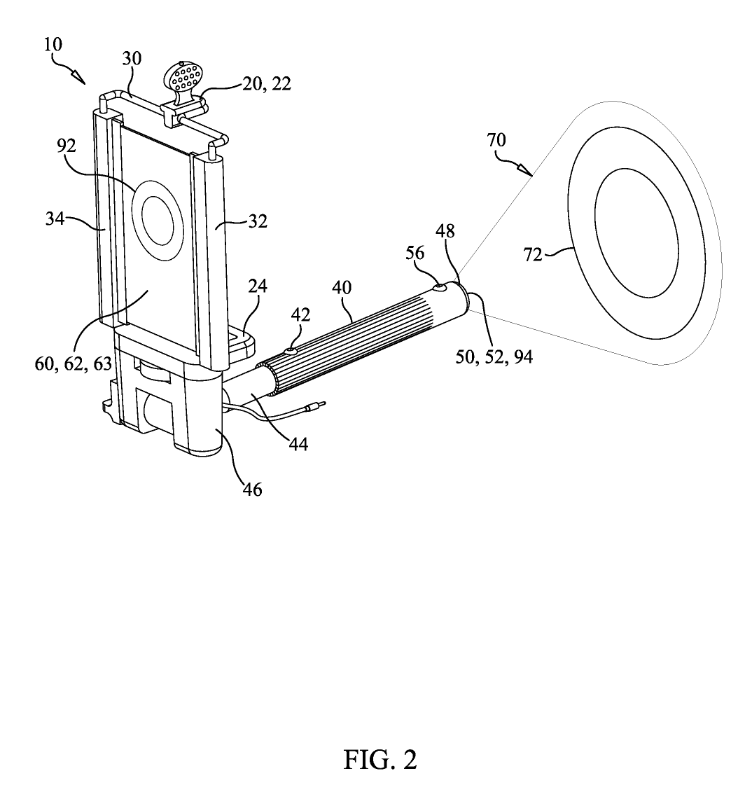

The branded monopod apparatus 10, or branded selfie stick, includes a telescoping pole 44, extendible to any of various preconfigured lengths, having a first end 48 and a second end 46, as shown in FIGS. 1 and 2. The first end 48 is coupled to or includes a handle 40, while the second end 46 may be coupled to or may include a ball swivel joint 80. The telescoping pole 44 may be retracted such that the handle 40 and ball swivel joint 80 are closer together, and extended such that the handle 40 and ball swivel joint 80 are farther apart.

An adjustable clamp 20 including a clamp frame 30 may be coupled to the ball swivel joint 80 on a side of the ball swivel joint 80 opposite the telescoping pole 44. The clamp frame 30 includes at least two opposing sides. For example, the clamp frame 30 may include a top 22, a bottom 24, a first side 32 and a second side 34 defining an insert area 60. A panel 63, such as a plastic card, may be secured within the insert area 60 and may have a front side 62 (FIG. 1) and a back side 64 (FIG. 2). For example, the panel 63 may have opposing ends glued to and/or supported within the first side 32 and the second side 34. However, alternative means for securing the panel 63 to all or portions of the clamp frame 30 are also contemplated. As shown in FIG. 1, brand, logo, or other advertising information 90 may be displayed on the front side 62 of the panel 63. Brand, logo, or other advertising information 92 may also be displayed on the back side 64 of the panel 63, as shown in FIG. 2.

Portions of the adjustable clamp 20 may be movable to clamp a recording device, such as a smartphone, therebetween, in a known fashion. The portions of the adjustable clamp 20 that secure the recording device may or may not be the same portions that secure the panel 63. With the recording device secured with the adjustable clamp 20, the telescoping pole 44 may be extended or retracted in a known fashion to reposition the device relative to a user grasping the handle 40. For example, a user may extend the telescoping pole 44 to position a recording device beyond the arm's normal reach and capture a picture of oneself, or a “selfie.” Additionally, or alternatively, the recording device may be rotated or tilted relative to the handle 40 using the ball swivel joint 80.

The handle 40 may include a first push button 42 for actuating the smartphone device, such as to capture a picture with the smartphone device. That is, the monopod apparatus 10 may include the requisite electronic connections to enable the first push button 42 to actuate the capture functionality of the recording device, for example a smartphone. According to a specific example, the monopod apparatus 10 may include a phone jack cable that may be plugged into the headphone jack of the smartphone device to enable the first push button 42 to actuate the recording functionality of the smartphone. After capturing the desired images, the telescoping pole 44 may be retracted, or shortened, and the recording device may be removed from the adjustable clamp 20. Again, other recording devices or electronic devices may be supported by and/or used with the branded monopod apparatus 10 without deviating from the scope of the present disclosure.

The branded monopod apparatus 10 may further include a light source 50 positioned to emit light from the monopod apparatus 10 through a lens 52. For example, the light source 50 may be housed within the handle 40 or telescoping pole 44. As shown, the handle 40 may include a second push button 56 for actuating the light source 50. According to some embodiments, the light source 50 of the monopod apparatus 10, which may be powered by a rechargeable battery, such as a USB rechargeable battery, may simply be used as a flashlight. According to other embodiments, the lens 52 may include an image 94 for projection onto a surface 70 when light is being emitted from the light source 50. A projected image 72 from the monopod apparatus 10 may be a brand, logo, or other advertising information. As such, the handle 40 may also be referred to as a projector handle.

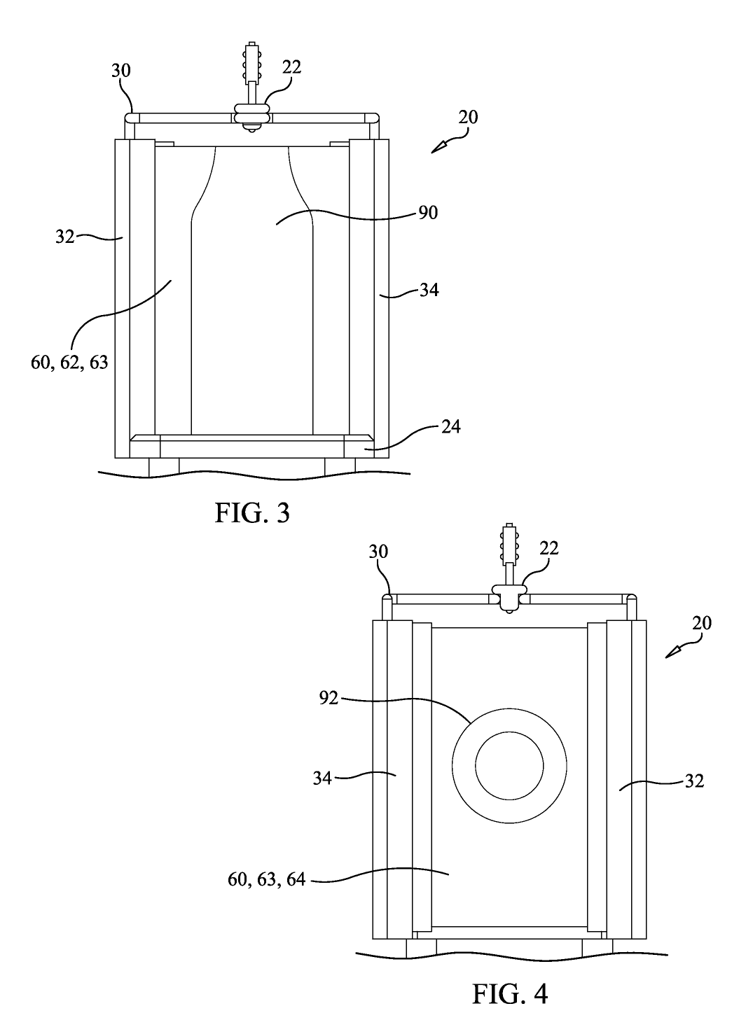

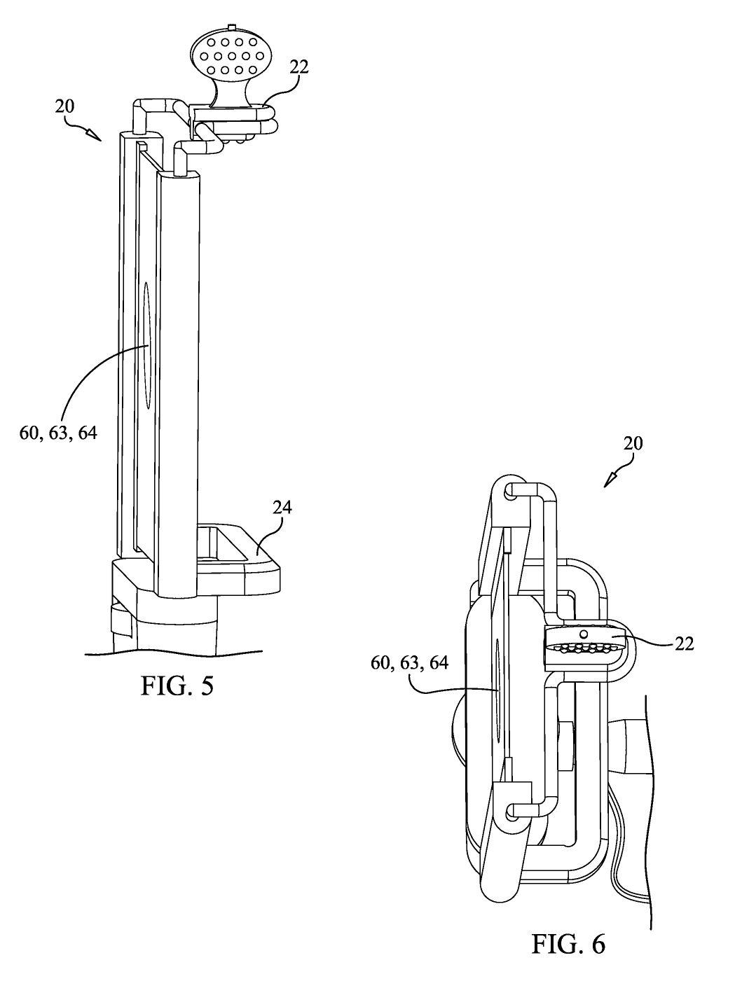

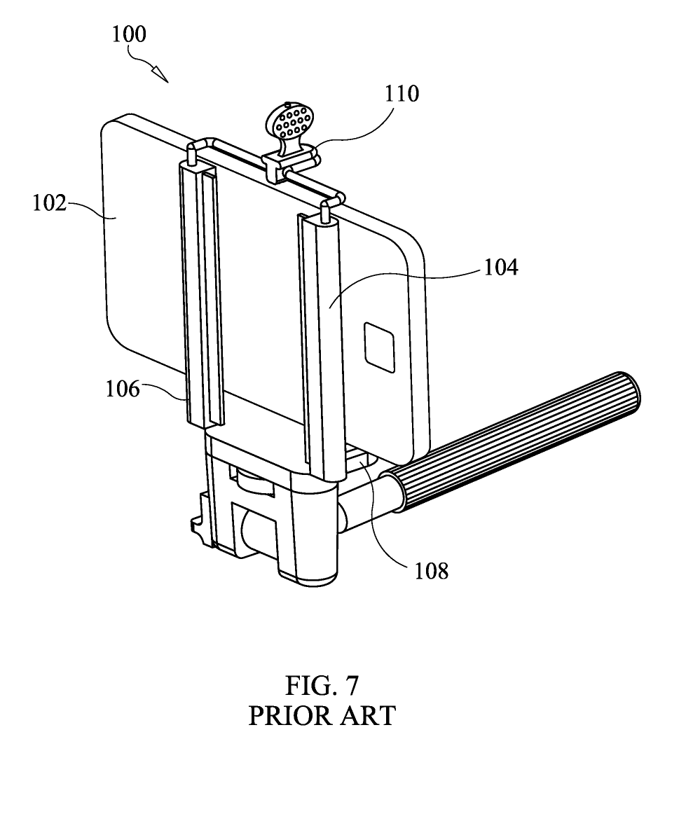

As shown in FIGS. 3 and 4, the clamp frame 30 defines a relatively large insert area 60 for panel 63. FIG. 3 illustrates the front side 62 of the panel 63, while FIG. 4 illustrates the back side 64. A side view and top view of the clamp frame 30 are depicted in FIGS. 5 and 6, respectively. The panel 63 may span the entire insert area 60 and is visible from both sides of the apparatus 10 and the back side 64 of the panel 63 may remain visible even while a smartphone, or other recording device, is secured within the clamp frame 30 in front of, or adjacent to, the front side 62 of the panel 63. Alternative, panel 63 may span only a portion of insert area 60. Additional advertising material may be in the form of stickers placed in various locations, including on the telescoping pole 44 or handle 40 of the apparatus 10. Further, the handle 40 may be a projector handle configured to project an advertising image, such as projected image 72, as described above. The branded monopod apparatus 10 of the present disclosure, thus, provides a maximum amount of marketing and advertising material exposure for an increasingly popular sales or promotional product.

While the invention has been illustrated and described in detail in the foregoing drawings and description, the same is to be considered as illustrative and not restrictive in character, it being understood that only illustrative embodiments thereof have been shown and described and that all changes and modifications that come within the spirit and scope of the invention as defined in the claims and summary are desired to be protected.

What is claimed is:

1. A monopod apparatus for a recording device, comprising:
a telescoping pole with a first end and a second end;
a handle coupled to the first end of the telescoping pole;
an adjustable clamp for securing the recording device, including a clamp frame coupled at the second end of the telescoping pole;
wherein the clamp frame includes at least two opposing sides defining an insert area; and
a panel secured within the insert area.

2. The monopod apparatus of claim 1, wherein the panel includes advertising information on a front side.

3. The monopod apparatus of claim 1, wherein the panel includes advertising information on a back side.

4. The monopod apparatus of claim 1, wherein the panel includes advertising information on a front side and a back side.

5. The monopod apparatus of claim 1, further including a ball swivel joint coupled to the second end of the telescoping pole, wherein the adjustable clamp is coupled to the ball swivel joint on a side of the ball swivel joint opposite the telescoping pole.

6. The monopod apparatus of claim 1, wherein portions of the adjustable clamp are movable to clamp a recording device therebetween.

7. The monopod apparatus of claim 3, wherein the handle includes a first push button for actuating the smartphone device.

8. The monopod apparatus of claim 1, further including a light source positioned to emit light from the monopod apparatus through a lens.

9. The monopod apparatus of claim 5, wherein the handle includes a second push button for actuating the light source.

10. The monopod apparatus of claim 5, wherein the lens includes an image for projection onto a surface when light is being emitted from the light source.

11. A monopod apparatus, comprising:
a telescoping pole with a first end and a second end;
an adjustable clamp including a clamp frame coupled at the second end of the telescoping pole;
wherein the clamp frame includes at least two opposing sides; and
a panel coupled between the at least two opposing sides;
wherein portions of the adjustable clamp are movable to clamp a recording device therebetween.
